(19) United States
(12) Patent Application Publication
(10) Pub. No.: US 2009/0277563 A1
(43) Pub. Date: Nov. 12, 2009

(54) METHOD FOR TESTING AND REPAIRING ADHESIVE BONDS

(75) Inventors: Pei-Chung Wang, Shanghai (CN); John D. Fickes, Brighton, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/348,955

(22) Filed: Jan. 6, 2009

Related U.S. Application Data
(60) Provisional application No. 61/051,532, filed on May 8, 2008.

(51) Int. Cl. B32B 38/00; G01N 3/00

(52) U.S. Cl. 156/64; 73/788; 702/42

(57) ABSTRACT

A method for testing adhesive bond quality includes subjecting an adhesively-bonded workpiece to a known loading function. The loading function may be cyclic, linear, or nonlinear, and configured not to damage the workpiece. Response characteristics of the workpiece are measured during the loading. Measured response characteristics are compared with baseline or nominal characteristics and the adhesive bond quality is determined from the resulting comparison. A differential signal may be generated based upon the comparison of measured response and baseline characteristics and used to determine the adhesive bond quality, possibly with an algorithm. Being within the acceptable range is indicative of acceptable adhesive bond quality. The root cause of failure may be determined and a course of action based thereupon; including: localized curing, inspection, repair, and destruction. Following corrective courses of action, the workpiece may be re-tested and compared again to the baseline.

### CROSS-REFERENCE TO RELATED APPLICATIONS

This application claims the benefit of U.S. Provisional Application No. 61/051,532, filed May 8, 2008, which is hereby incorporated by reference in its entirety.

### TECHNICAL FIELD

This disclosure concerns testing of adhesively-joined workpieces during manufacturing processes.

### BACKGROUND OF THE INVENTION

An inspection method for use in a high-volume, low-cost production environment is preferably fast, convenient, cost-effective, and able to effectively assure a minimum acceptable level of joint quality. Automotive and industrial manufacturers often rely on destructive testing, such as a chisel test or peel test, to assess bond or weld quality and to assess the welding process. The quality of the tested joint is determined largely based upon bond size and failure mode, which may be extrapolated or interpreted to estimate the overall quality of the production process.

While the chisel test has been widely used for weld inspection, no practical method is available for inspection of adhesive bonds. Furthermore, the chisel test damages or destroys the workpiece, making it unsuitable for testing all, or large numbers, of workpieces in the production line.

### SUMMARY OF THE INVENTION

A method or algorithm for testing adhesive bond quality is provided. The method includes subjecting a workpiece to a known loading function after the workpiece has had an adhesive and a curing process applied to create an adhesive bond. The response characteristics of the workpiece are measured during the loading. Measured response characteristics are compared with baseline or nominal characteristics and the adhesive bond quality is determined from the resulting comparison.

The method may further include generating a differential signal based upon the comparison of measured response and baseline characteristics and using the generated differential signal to determine the adhesive bond quality. Furthermore, an algorithm may be utilized to process the differential signal.

Additionally, the method may determine if the differential signal is within an acceptable range. If the differential signal is within the acceptable range it is indicative of the workpiece having acceptable adhesive bond quality. If the differential signal is not within the acceptable range, the method may then determine the root cause of failure from the differential signal. A course of action is then based upon the determined root cause of failure.

Possible courses of action include any one of applying localized curing to the adhesive, inspecting the workpiece, repairing the workpiece, and destroying the workpiece. One embodiment applies corrective localized curing in the form of heating the workpiece. Comparison of the tested response characteristic and baseline characteristic may be made using either a hysteretic loss or a load-displacement response.

After corrective measures, such as application of localized curing, the method may re-subject the workpiece to the known loading function. A second response characteristic of the workpiece is measured while the workpiece is subjected to the known loading function, and this second response characteristic may then also be compared to the baseline characteristic. A second root cause of failure for the re-tested workpiece is then determined from the comparison of the second response characteristic to the baseline characteristic. After identification of the second root cause of failure, a second course of action may be determined based upon the second determined root cause of failure.

The known loading function is configured not to damage the workpiece during either the original test run or subsequent runs (such as those occurring after corrective measures). The known loading function may be a linear cyclic function or a nonlinear cyclic function.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic representation of one embodiment of a testing system capable of being used with the claimed invention to test a workpiece having an adhesively-bonded joint;

FIG. 2 is a schematic graph representing illustrative benchmark characteristics of acceptable adhesive bonds and illustrative comparative characteristics of known discrepant adhesive bonds;

FIG. 3 is a schematic graph representing comparative hysteresis loops of acceptable adhesive joints and of undercured adhesive joints; and

FIG. 4 is a schematic flow chart of one embodiment of a method or algorithm for testing, analyzing, and repairing adhesive bonds.

### DESCRIPTION OF EMBODIMENTS

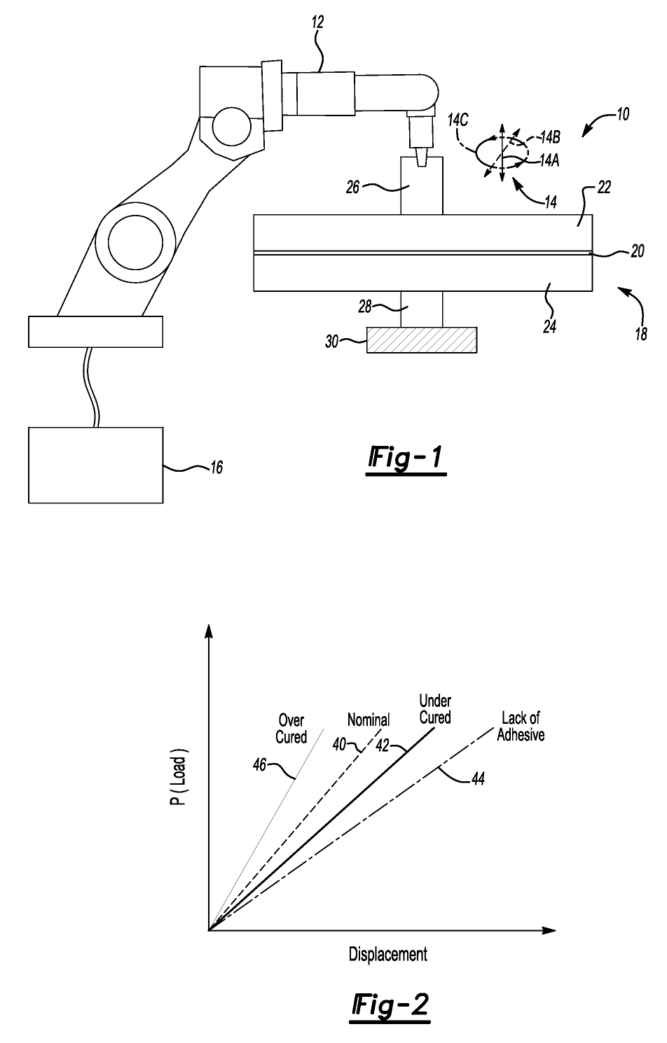

Referring to the drawings, wherein like reference numbers correspond to like or similar components throughout the several figures, there is shown in FIG. 1 an embodiment of a testing system 10. A testing machine or robot 12 is configured to produce a force 14 and to measure the resulting load-displacement response characteristic with a controller 16. Those having ordinary skill in the art will recognize that FIG. 1 is shown schematically, and the components shown therein may not be to scale.

Robot 12 subjects a workpiece 18 to the force 14. In the embodiment shown schematically in FIG. 1, workpiece 18 is composed of an adhesive 20 joining a first part 22 to a second part 24. On the production line prior to testing workpiece 18, the adhesive 20 may be applied to one or both of first and second parts 22 and 24, and may be applied by any method known to those having ordinary skill in the art, such as, without limitation: manual or automated dispensing, spraying, brushing, or submersion. The adhesive 20 may then undergo a curing process to adhesively bond the first and second parts 22 and 24. The term adhesive bond, as used herein, refers both to structural and sealing adhesives.

The testing system 10 shown in FIG. 1 includes a single layer of adhesive 20 between two parts 22 and 24. However, the testing system 10, and method 100 described below, may be used on workpieces 18 having more than two parts and multiple layers of adhesive 20. These stack-ups of parts (22, 24, or additional parts) may include multiple sheets of steel, aluminum, non-metallic materials, composites, or other materials recognizable to those having ordinary skill in the art. Furthermore, adhesive 20 may be used to join parts 22 and 24 formed of different materials.

Force 14 may be cyclic or may be applied as a single cycle, and is communicated to workpiece 18 through a dynamic grip 26 and a static grip 28. The dynamic grip 26 connects the robot to the first part 22, and the static grip 28 connects the second part 24 to a solid, or grounded, base 30. Those having ordinary skill in the art will recognize that the order and relative location of the static and dynamic grips 28 and 26 are not limiting, and that both grips 26 and 28 may be dynamic. As used herein, the term cyclic refers either to a force 14 having multiple cycles or a testing system 10 which is measuring both the loading and unloading of the workpiece 18, such that the graphically-represented load-displacement characteristic forms a loop or single cycle.

Those having ordinary skill in the art will recognize that robot 12 may be any number of testing devices configured to impart a force and measure the resulting response. Possible testing devices include, without limitation: an electrical servomotor arm (servo gun), single or dual column material-testing equipment, or any other device known to those having ordinary skill in the art as capable of imparting the forces required for testing a specific workpiece design. The industrial-type robot 12 shown in this embodiment is used due to its adaptability for multiple manufacturing processes, ability to incorporate various end effectors, and ability to carry out fully automated testing on assembly, manufacturing, or production lines.

The embodiment shown in FIG. 1 includes a substantially perpendicular (with respect to the adhesive) cyclic loading function, such as force 14A. However, those having ordinary skill in the art will understand that some applications may utilize a force such as 14B having lateral (shear) components; or may utilize a force such as 14C, having multi-directional or circular loading functions. Furthermore, in some applications within the scope of the claimed invention, the load may not be cyclical.

The load and measurement controls for testing system 10 are included in the single controller 16. However, the measuring and loading systems may be separated, with measurement being accomplished through additional sensors (strain gauges and displacement sensors, for example) fed into one or more separate controllers or computers.

In the embodiment shown schematically in FIG. 1, the workpiece 18 is generally planar. However, those having ordinary skill in the art will recognize that significantly more complex parts and adhesive patterns may be tested within the scope of the claims. Furthermore, adhesive patterns or arrays may be used to join multiple, possibly distinct, areas of the parts 22 and 24 (or additional parts).

In the embodiment shown schematically in FIG. 1, the dynamic and static grips 26 and 28 are discrete components from the workpiece 18, which then attach to or grab first and second parts 22 and 24. However, one or both of the grips 26 and 28 could be integrated into first and second parts 22 and 24. For example, the robot 12 could grasp a grip 26 which is an integral portion of the first part 22. Furthermore, either, or both, of robot 12 or base 30 could be configured to directly grasp respective parts 22 and 24. Base 30 and static grip 28 could also be integrated into a single component.

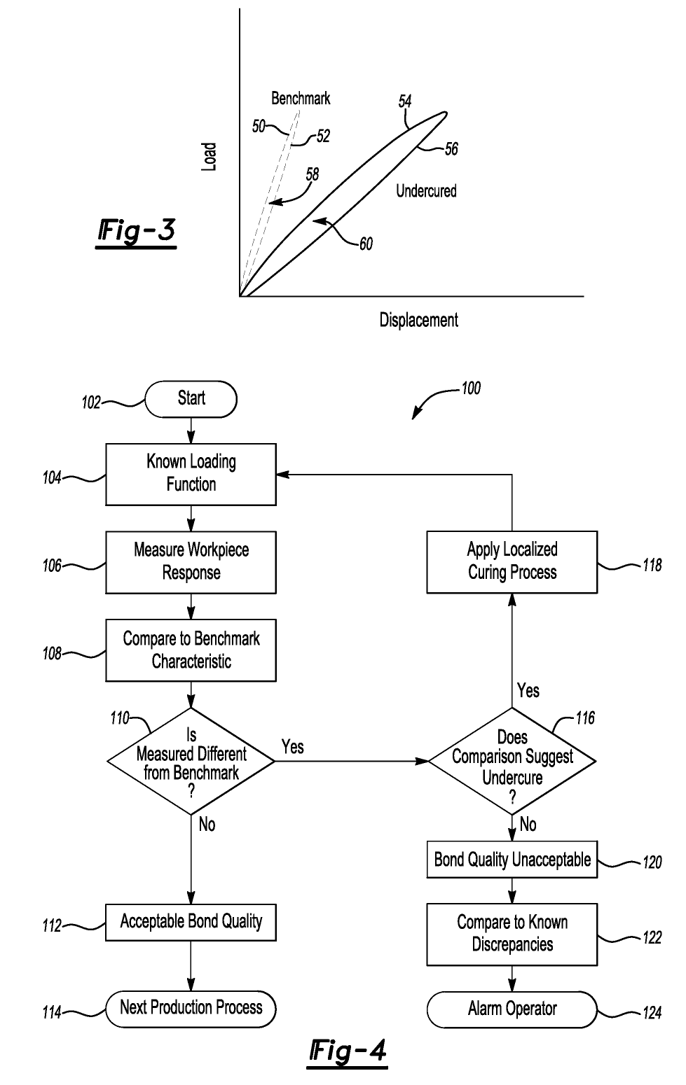

Referring now to FIGS. 2 and 3, there are shown representative graphs of load-displacement characteristics created during testing of various workpieces 18 in the testing system 10 or other testing system embodiments. These graphs show generalized examples of how the testing system 10 may be used to diagnose adhesive bond quality between the adhesive 20, the first part 22, and the second part 24.

FIG. 2 shows comparative representations of load-displacement responses to a unidirectional application of force 14 to a theoretical workpiece 18 having varied adhesive bond qualities in adhesive 20. Line 40 shows a nominal, baseline, or benchmark characteristic. The nominal line 40 is created by combination or analysis of the load-displacement response characteristics of multiple workpieces 18 which are known to have the desired adhesive bond quality (successful application and curing of the adhesive 20 during the manufacturing process).

Those having ordinary skill in the art will recognize many techniques for determining the ideal adhesive bond quality of workpieces 18 that may be used to define line 40. Nominal line 40 may be established through laboratory testing, computer modeling, statistical analysis of workpieces 18 produced during production line test runs, or with destructive methods after testing system 10 has measured the load-displacement response characteristic for the workpiece 18.

Lines 42, 44, and 46 represent deviations from ideal adhesive bond quality. As will be recognized by those having ordinary skill in the art, these characteristics are representative only, as are the shape, magnitude, and relative values of lines 42, 44, and 46. Depending upon the type of adhesive 20, the curing process, the shape, size and thickness of workpiece 18, and other factors known to those having ordinary skill in the art; the shape of the lines 40-46, and the positions of lines 42-46 relative to nominal line 40, may vary from that shown in FIG. 2. The specific curves, and relations between curves shown as lines 40-46 in FIG. 2, are representative approximations of common responses of adhesives 20 having the identified characteristics.

Most adhesives require a curing process to take the adhesive from a viscous, liquid state to the final (usually solid or substantially solid) state. Curing may be accomplished with the application of chemical additives, ultraviolet radiation, an electron beam, pressure, heat, or any other suitable curing process known to those having ordinary skill in the art. The adhesive curing process influences the mechanical properties of the adhesive 20. The testing system 10 can use either load-displacement responses or hysteresis loop measurements to differentiate the amount (and quality) of the curing.

As the workpiece 18 increases in size and complexity, it may become more difficult to properly and consistently cure all of the adhesive 20 bonding parts 22 and 24 together. For example, in a heat-cured adhesive, variations in the thickness of parts 22 and 24 may cause portions of adhesive 20 to heat up very quickly while other portions (adjacent to thicker sections of parts 22 and 24 or in completely enclosed areas of workpiece 18) may not achieve curing temperature. Those having ordinary skill in the art will recognize other curing deficiencies that may result during the production process.

Undercured adhesive 20 may have less viscosity and low shear modulus. Line 42 represents an approximate load-displacement response characteristic of a tested workpiece 18 having undercured adhesive 20. Relative to the benchmark characteristic of the nominal line 40, the undercured adhesive 20 results in a load-displacement line 42 having less slope than nominal line 40, such that displacement of the workpiece 18 occurs at relatively less force than in the properly-cured adhesive 20.

Lack of adhesive may occur where there is a problem in the adhesive application process or where adhesive supply suddenly malfunctions or is interrupted. Line 44 shows an approximation of the relative load-displacement characteristic effects of a workpiece 18 lacking in adhesive 20. Lack of adhesive may include gapped, partial, porous, spotty, or thin adhesive; and results in a line 44 having relatively less slope than either nominal line 40 or undercured line 42.

FIG. 2 also shows an approximate characteristic of overcured adhesive 20 on line 46. Overcure has increased slope relative to the benchmark characteristic of nominal line 40, as overcured adhesive 20 requires relatively more force to displace the workpiece 18.

Hysteresis is another characteristic of adhesive bond quality that is measurable with testing system 10. Hysteresis is a retardation of an effect when the forces acting upon a body are changed (as if from viscosity or internal friction). The hysteresis can be seen on load-displacement graphs as the separation between the loading and unloading curves, where the area in the center of the hysteresis loop is representative of the energy dissipated.

FIG. 3 shows approximate comparative load-displacement responses of a cyclic force 14 applied to a theoretical workpiece 18 having varied adhesive bond qualities in adhesive 20. The benchmark loop (on the left in FIG. 3) is obtained similarly to the nominal or benchmark curve in FIG. 2. The benchmark consists of a curve 50, which represents the loading path of cyclic force 14, and a curve 52, which represents the unloading path of cyclic force 14. An area 58 between curves 50 and 52 represents the hysteretic loss in the benchmark workpiece 18. Since stress and strain are not in phase for a viscoelastic material (such as adhesive 20), the stress-strain curve forms a loop. Determination of the hysteresis loss of an adhesively-bonded joint can be used to estimate the degree of the adhesive curing.

The second loop (on the right in FIG. 3) may be characteristic of undercured adhesive 20 in workpiece 18. Curve 54 is the loading path for the undercured workpiece 18 and curve 56 is the unloading path as the cyclic force 14 returns to its starting point. Comparison of the areas in between the respective curves may suggest the quality of the adhesive bond 20.

An area 60—measured either as thickness or the total area of the hysteresis loop—may be used to compare the hysteretic loss of a tested workpiece 18 to benchmark workpiece 18, represented by area 58. If area 60 is larger than benchmark area 58, the adhesive 20 in the tested workpiece 18 may be undercured. This comparison may be made visually by a worker monitoring testing system 10, or may be an automated comparison of data by the controller 16.

FIG. 4 is a schematic flow chart showing one embodiment of an algorithm or method 100 for testing, analyzing, and repairing adhesive bonds. Much of the method 100 may, but need not necessarily, be implemented with the components and elements of the testing system 10 described herein. For descriptive purposes, method 100 is described with reference to elements of testing system 10.

Method 100 begins at an initialization or start step 102. Start 102 may include clearing the memory of controller 16 and any other associated electronics. Start 102 may occur whenever the production line into which method 100 is incorporated produces a workpiece 18 ready for inspection. Those having ordinary skill in the art will recognize that, depending upon the application, method 100 may test each workpiece 18 passing through the production line, or may test random workpieces 18 for quality control.

Workpiece 18 is subjected to a known loading function in step 104 and the response characteristic of the workpiece 18 to this load is measured in step 106. As will be recognized by those having ordinary skill in the art, the measured response characteristic may be load-displacement data, displacement-time data, other material properties and time functions, or any other characteristic known to those having ordinary skill in the art as being suggestive of adhesive bond quality.

The measured response characteristic is compared to a previously-determined baseline or benchmark characteristic in step 108. The comparison of step 108 will be used to determine the adhesive bond quality of workpiece 18. Those having ordinary skill in the art will recognize that the measured characteristic may have some minimal level of deviation from the benchmark characteristic and still indicate that an acceptable adhesive bond quality between adhesive 20 and parts 22 and 24.

The comparison step 108 may occur in several ways. An operator may watch a monitor and visually compare the measured load-displacement (or other data) characteristic to the benchmark. Either the comparison step 108 or the subsequent decision step 110 may produce a differential signal based upon the comparison. This differential signal could include the direction and magnitude of the difference between the measured response characteristic and the benchmark characteristic. Those skilled in the art will recognize that a differential signal of this type can be used both to determine acceptability of adhesive 20 and to determine the root cause of any detected failure.

If the comparison in step 108 shows that the workpiece 18 is within an acceptable range, a decision step 110 recognizes that the workpiece 18 and adhesive 20 have an acceptable bond quality, and method 100 proceeds to step 112. Step 112 may include, without limitation: logging data regarding the workpiece's (18) response characteristic, alerting an operator to remove workpiece 18 from the testing system 10, or noting (such as with a unique identification number) that the specific workpiece 18 has acceptable bond quality. The workpiece 18 is then passed to the next production process or stage, if applicable, or the method 100 ends, at a termination step 114.

If step 110 determines that workpiece 18 is outside of the acceptable limits—e.g. the measured response characteristic is substantively different from the benchmark—method 100 proceeds to a decision step 116, where the algorithm begins attempting to determine the root cause of the failure. Step 116 determines whether or not the comparison of measured response and benchmark characteristics—and differential signal, if applicable—suggests undercured adhesive 20. Undercure may be suggested by a large hysteresis loop in the load-displacement curve (as represented in FIG. 3) measured in step 108. Those having ordinary skill in the art will recognize other indicators of undercured adhesive 20 that may be determined in decision step 116.

If decision step 116 determines the workpiece 18 likely has undercured adhesive 20, method 100 moves to step 118 and localized curing is applied to the adhesive 20. Localized curing may correct the adhesive bond quality by curing areas of adhesive 20 that are prone to undercure. This step may occur by notifying the operator of the need for localized curing or may be automated within production line. The localized curing may be accomplished through application of heat, light, or any other method of curing adhesive 20 known to those having ordinary skill in the art.

Following localized curing, the workpiece 18 returns to step 104 to be reloaded and tested to determine whether or not the adhesive bond quality is now acceptable. If the localized curing applied in step 118 did not bring the adhesive bond quality within the acceptable range, the method 100 may return to decision step 116 with the same workpiece 18. To keep the workpiece 18 from continuously looping through this portion of method 100, decision step 116 may include tracking of the workpiece 18 and factor previous attempts to apply localized curing into the decision. If a tracking device—such as an RFID tag or barcode—alerts the system that the workpiece has already received multiple applications of localized curing, decision step 116 can then determine that the characteristics of workpiece 18 no longer suggest undercure, or cannot be corrected with the localized curing already attempted.

If the decision step 116 determines that the characteristics do not suggest undercure, method 100 proceeds to step 120 and the method determines that the bond quality of workpiece 18 is unacceptable. Method 100 then compares the measured response characteristics—and differential signal, if applicable—to characteristics of known adhesive deficiencies. As described above, comparison of measured response characteristics to known deficiency patterns may suggest the root cause of the adhesive failure (overcure, missing or porous adhesive, undercure, et cetera) and may further suggest the appropriate course of action for the workpiece 18.

The operator is then alarmed, at a termination step 124, that the method 100 has determined that the workpiece 18 likely has unacceptable bond quality. Several subsequent steps may occur after the operator is alarmed, and may depend upon whether or not step 122 determined the root cause of the failure. The operator may investigate the workpiece 18 and employ other methods of testing the adhesive bond quality, such as destructive testing. This inspection may suggest to the operator or control system that there is a problem in the production line, such as a problem in the dispensing system or improper temperature in a curing oven, and the operator or control system may be able to take corrective action before additional unsatisfactory workpieces 18 are produced.

The operator will determine the proper course of action for workpiece 18 depending upon the root cause of the failure of the adhesive 20. Either the operator or an automated step in the production process may automatically dispose of, destroy, or recycle the failed workpiece 18. Alternatively, the operator may be able to identify a problem not uncovered by the algorithm of method 100, and may be able to repair the workpiece 18 to an acceptable bond quality.

Adhesive bond, as used herein, refers both to structural and sealing adhesives. The testing system 10 and method 100, or other embodiments within the scope of the claims, may also be used to test adhesives designed to seal joints and interfaces between parts. Unlike bonding adhesives, sealing adhesives provide less structural support, and are used to prevent the penetration of air, noise, dust, liquid, et cetera from one location through a barrier into another. Sealing adhesives may be tested similarly to bonding adhesive, but may have a relatively smaller force applied during loading of the workpiece 18.

While the best modes and other embodiments for carrying out the claimed invention have been described in detail, those familiar with the art to which this invention relates will recognize various alternative designs and embodiments for practicing the invention within the scope of the appended claims.

1. A method of testing adhesive bond quality, comprising:
subjecting a workpiece to a known loading function, wherein said workpiece has had an adhesive and a curing process applied to create an adhesive bond;
measuring a response characteristic of said workpiece while subject to said known loading function;
comparing said response characteristic to a baseline characteristic; and
determining the adhesive bond quality from said response and baseline characteristics.

2. The method of claim 1, further comprising:
generating a differential signal based upon said comparison of said response and baseline characteristics; and
determining the adhesive bond quality from said differential signal.

3. The method of claim 2, further comprising using an algorithm to process said differential signal to determine adhesive bond quality.

4. The method of claim 3, wherein said algorithm further includes:
determining if said differential signal is within an acceptable range, wherein said differential signal being within said acceptable range is indicative of said workpiece having acceptable adhesive bond quality;
determining a root cause of failure from said differential signal if said differential signal is not within said acceptable range;
determining a course of action based upon said determined root cause of failure.

5. The method of claim 4, wherein said course of action includes one of applying localized curing to the adhesive, inspecting said workpiece, repairing said workpiece, and destroying said workpiece.

6. The method of claim 5, wherein said applying localized curing includes heating said workpiece.

7. The method of claim 6, wherein said response characteristic and said baseline characteristic are one of hysteretic loss and load-displacement response.

8. A method of testing adhesive bond quality, comprising:
subjecting a workpiece to a known loading function, wherein said workpiece has had an adhesive and a curing process applied to create an adhesive bond;
measuring a response characteristic of said workpiece while subject to said known loading function;
comparing said response characteristic to a baseline characteristic;
determining a root cause of failure from said comparing said response characteristic to said baseline characteristic; and
determining a course of action based upon said determined root cause of failure.

9. The method of claim 8, wherein said response characteristic and said baseline characteristic are one of hysteretic loss and load-displacement response.

10. The method of claim 9, wherein said course of action includes one of applying localized curing to the adhesive, inspecting said workpiece, repairing said workpiece, and destroying said workpiece.

11. The method of claim 10, wherein said applying localized curing includes heating said workpiece.

12. The method of claim 11, further comprising:
re-subjecting said workpiece to said known loading function after said applying localized curing;
measuring a second response characteristic of said workpiece while subject to said known loading function;
comparing said second response characteristic to said baseline characteristic;
determining a second root cause of failure from said comparing said second response characteristic to said baseline characteristic; and
determining a second course of action based upon said second determined root cause of failure.

13. The method of claim 12, wherein said known loading function is configured not to damage said workpiece.

14. The method of claim 13, wherein said known loading function is a linear cyclic function.

15. The method of claim 13, wherein said known loading function is a nonlinear cyclic function.
